(19) United States
(12) Patent Application Publication
(10) Pub. No.: US 2025/0005447 A1
(43) Pub. Date: Jan. 2, 2025

(54) TECHNIQUES FOR COMBINING LEARNING-BASED AND RULE-BASED MODEL PREDICTIONS

(71) Applicant: NVIDIA CORPORATION, Santa Clara, CA (US)

(72) Inventors: Sushant VEER, Sunnyvale, CA (US); Apoorva SHARMA, Oakland, CA (US); Marco PAVONE, Stanford, CA (US)

(21) Appl. No.: 18/632,931

(22) Filed: Apr. 11, 2024

Related U.S. Application Data
(60) Provisional application No. 63/523,921, filed on Jun. 28, 2023.

(51) Int. Cl. G06N 20/00

(52) U.S. Cl. CPC G06N 20/00

(57) ABSTRACT

One embodiment of a method for processing data includes performing one or more operations to determine a performance of one or more predefined rules based on data that is received and one or more first predictions generated using the one or more predefined rules, performing one or more operations to determine a performance of a trained machine learning model based on the data and one or more second predictions generated using the trained machine learning model, processing the data using the one or more predefined rules to generate one or more third predictions, processing the data using the trained machine learning model to generate one or more fourth predictions, and generating one or more fifth predictions based on the one or more third predictions, the one or more fourth predictions, the performance of the one or more predefined rules, and the performance of the trained machine learning model.

### CROSS-REFERENCE TO RELATED APPLICATIONS

This application claims benefit of the United States Provisional patent application titled “COMBINING LEARNING-BASED AND RULE-BASED TRAJECTORY PREDICTORS,” filed Jun. 28, 2023, and having Ser. No. 63/523,921. The subject matter of this related application is hereby incorporated herein by reference.

### BACKGROUND

### Field of the Various Embodiments

The embodiments of the present disclosure relate generally to the fields of computer science, machine learning, and artificial intelligence, and more specifically, to techniques for combining learning-based and rule-based model predictions.

### DESCRIPTION OF THE RELATED ART

Machine learning can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data. In turn, the discovered information can be used to guide decisions and/or perform actions related to the data and/or other similar data.

Learning-based prediction models are machine learning models that use a data-driven approach to learn from vast amounts of data to predict behaviors. Machine learning and deep learning techniques can be employed to train learning-based prediction models to understand patterns and make predictions about future states. For example, a learning-based prediction model could be trained on traffic data to predict future vehicle positions. As a specific example, a learning-based trajectory prediction model can be trained to predict the trajectory of a vehicle through a roundabout given the current velocities and trajectories of surrounding vehicles.

One drawback of conventional learning-based prediction models is these models can misinterpret new situations that are not present in the historical data used to train the learning-based prediction models, leading to inaccurate predictions. For example, a learning-based trajectory prediction model that is trained predominantly on data from urban environments driving can struggle to accurately predict vehicle behavior in rural environments where driving patterns are different from urban environments.

Another drawback of conventional learning-based prediction models is that these models can learn from patterns in data without understanding the causality behind the patterns. In particular, the machine learning and deep learning techniques used to train conventional learning-based prediction models can overfit to the historical training data such that the trained learning-based prediction models are unable to generalize to new scenarios. For example, a conventional learning-based trajectory prediction model can incorrectly predict that a vehicle will stop at a green traffic signal after observing such behavior during training due to heavy traffic conditions, not because the signal necessitated stopping.

As the foregoing illustrates, what is needed in the art are more effective techniques for making predictions using models.

### SUMMARY

One embodiment of the present disclosure sets forth a computer-implemented method for processing data. The method includes performing one or more operations to determine a performance of one or more predefined rules based on data that is received and one or more first predictions generated using the one or more predefined rules. The method further includes performing one or more operations to determine a performance of a trained machine learning model based on the data and one or more second predictions generated using the trained machine learning model. The method also includes processing the data using the one or more predefined rules to generate one or more third predictions, and processing the data using the trained machine learning model to generate one or more fourth predictions. In addition, the method includes generating one or more fifth predictions based on the one or more third predictions, the one or more fourth predictions, the performance of the one or more predefined rules, and the performance of the trained machine learning model.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, by combining predictions from a rule-based model with predictions from a learning-based model, the disclosed techniques can generate more accurate predictions for scenarios not included in historical data used to train the learning-based model. Furthermore, the disclosed techniques integrate causal reasoning through rule-based logic in the rule-based model, thereby enhancing the generalization capabilities to new scenarios. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computing system configured to implement one or more aspects of the various embodiments;

FIG. 2A is an illustration of an exemplar autonomous vehicle, in accordance with various embodiments;

FIG. 2B illustrates exemplar camera locations and fields of view for the exemplar autonomous vehicle of FIG. 2A, in accordance with various embodiments;

FIG. 2C is a block diagram of an exemplar system architecture for the exemplar autonomous vehicle of FIG. 2A, in accordance with various embodiments;

FIG. 2D is a system diagram for communication between cloud-based server(s) and the exemplar autonomous vehicle of FIG. 2A, in accordance with various embodiments;

FIG. 3 is a more detailed illustration of the prediction application of FIG. 1, according to various embodiments;

FIG. 4 is a more detailed illustration of the belief update module of FIG. 3, according to various embodiments;

FIG. 5 is a more detailed illustration of the prediction fusion module of FIG. 3, according to various embodiments; and

FIG. 6 is a flow diagram of method steps for combining learning-based and rule-based predictions, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for combining predictions by a learning-based prediction model and predictions by a rule-based prediction model. In some embodiments, a prediction application initializes the learning-based and the rule-based prediction models and hyperparameters that define the number of outcome samples, prediction horizon, and a Bayesian learning rate. At each time step, the prediction application updates a history of outcomes predicted by both the rule-based and learning-based prediction models. The prediction application then observes a current environment state to calculate likelihoods, informing a belief about the reliability of each model. The belief is updated using the Bayes rule to obtain conditional probabilities of observing the current environment state given historical predictions by the rule-based and learning-based prediction models, and the belief can be calculated as a weighted sum of a ratio of the conditional probabilities and a prior belief. Subsequently, the prediction application samples new outcomes predicted by both the learning-based and rule-based prediction models. The samples are blended according to the updated belief to yield a fused predicted outcome. The fused predicted outcome represents the most likely outcome considering both the patterns learned from data by the learning-based prediction model and adherence to rules by the rule-based prediction model. The process iterates, continually refining the belief and improving the fused predicted outcome accuracy over time. The fused predicted outcome can be used in any suitable manner, such as to control an autonomous vehicle.

The techniques for generating predictions by combining predictions by a learning-based prediction model and a rule-based prediction model have many real-world applications. For example, those techniques could be used to generate predictions of vehicle trajectories within an environment that are, in turn, used to determine how to control an autonomous vehicle within the environment to avoid those vehicles. As a further example, those techniques could be used to generate predictions of trajectories of objects (e.g., humans) within an environment that are, in turn, used to determine how to control a robot within the environment.

The above examples are not in any way intended to be limiting. As persons skilled in the art will appreciate, as a general matter, the techniques for generating predictions described herein can be implemented in any suitable application.

### System Overview

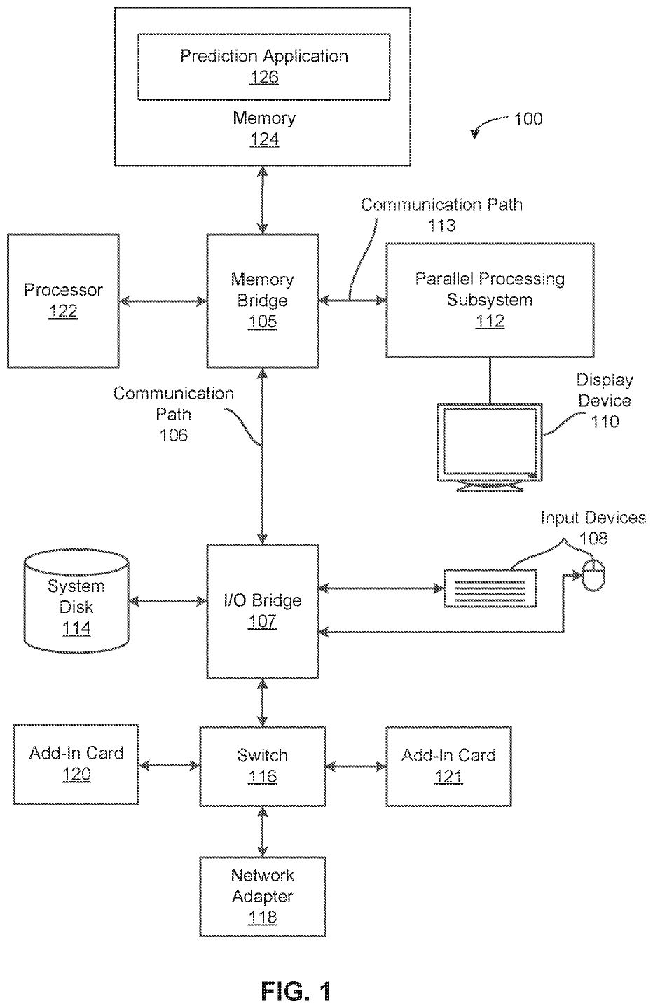

FIG. 1 is a block diagram of a computing system 100 configured to implement one or more aspects of the various embodiments. Computing system 100 can include any type of computing system, including, without limitation, a server machine, a server platform, a desktop machine, a laptop machine, a hand-held/mobile device, a digital kiosk, an in-vehicle infotainment system, and/or a wearable device. In some embodiments, computing system 100 is a server machine operating in a data center or a cloud computing environment that provides scalable computing resources as a service over a network.

In some embodiments, computing system 100 includes, without limitation, processor(s) 122 and memory(ies) 124 coupled to a parallel processing subsystem 112 via a memory bridge 105 and a communication path 106. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard, mouse, touch screen, sensor data analysis (e.g., evaluating gestures, speech, or other information about one or more uses in a field of view or sensory field of one or more sensors), and/or the like, and forward the input information to processor(s) 122 for processing. In some embodiments, computing system 100 can be a server machine in a cloud computing environment. In such embodiments, computer system 100 can not include input devices 108, but can receive equivalent input information by receiving commands (e.g., responsive to one or more inputs from a remote computing device) in the form of messages transmitted over a network and received via the network adapter 118. In some embodiments, switch 116 is configured to provide connections between I/O bridge 107 and other components of the computing system 100, such as a network adapter 118 and various add in cards 120 and 121.

In some embodiments, I/O bridge 107 is coupled to a system disk 214 that may be configured to store content and applications and data for use by processor(s) 112 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to I/O bridge 107 as well.

In some embodiments, memory bridge 105 may be a Northbridge chip, and I/O bridge 207 may be a Southbridge chip. In addition, communication paths 106 and 113, as well as other communication paths within computing system 100, can be implemented using any technically suitable protocols, including, without limitation, AGP (Accelerated Graphics Port), HyperTransport, or any other bus or point to point communication protocol known in the art.

In some embodiments, parallel processing subsystem 112 comprises a graphics subsystem that delivers pixels to an optional display device 210 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within parallel processing subsystem 112.

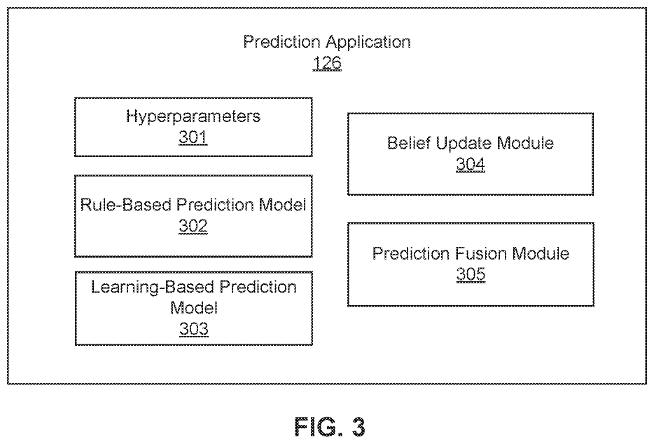

In some embodiments, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. System memory 124 includes at least one device driver configured to manage the processing operations of the one or more PPUs within parallel processing subsystem 112. In addition, system memory 124 includes a prediction application 126 that makes predictions using a combination of a learning-based prediction model and a rule-based prediction model, as discussed in greater detail below in conjunction with FIGS. 3-6. Although described herein primarily with respect to prediction application 126, techniques disclosed herein can also be implemented, either entirely or in part, in other software and/or hardware, such as in parallel processing subsystem 112.

In some embodiments, parallel processing subsystem 112 can be integrated with one or more of the other elements of FIG. 1 to form a single system. For example, parallel processing subsystem 112 can be integrated with processor 122 and other connection circuitry on a single chip to form a system on a chip (SoC).

In some embodiments, processor(s) 122 includes the primary processor of computing system 100, controlling and coordinating operations of other system components. In some embodiments, processor(s) 122 issues commands that control the operation of PPUs. In some embodiments, communication path 113 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 122, and the number of parallel processing subsystems 112, can be modified as desired. For example, in some embodiments, system memory 124 could be connected to processor(s) 122 directly rather than through memory bridge 105, and other devices can communicate with system memory 124 via memory bridge 105 and processor 122. In other embodiments, parallel processing subsystem 112 can be connected to I/O bridge 107 or directly to processor 122, rather than to memory bridge 105. In still other embodiments, I/O bridge 107 and memory bridge 105 can be integrated into a single chip instead of existing as one or more discrete devices. In certain embodiments, one or more components shown in FIG. 1 may not be present. For example, switch 116 could be eliminated, and network adapter 118 and add in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

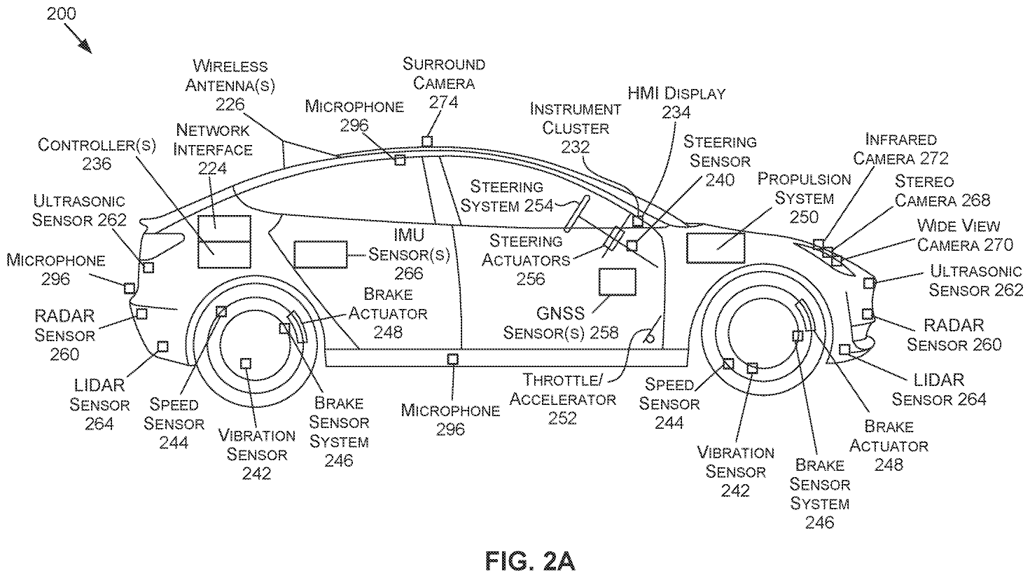

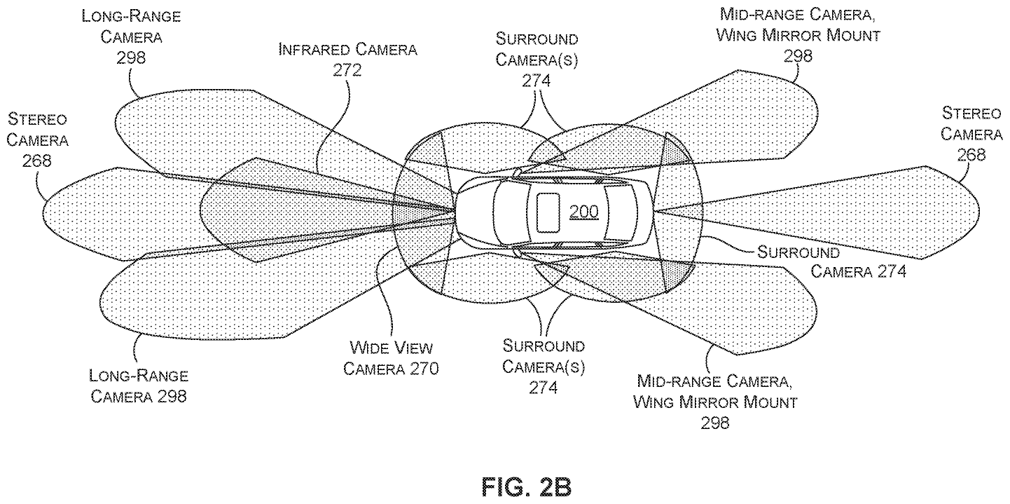

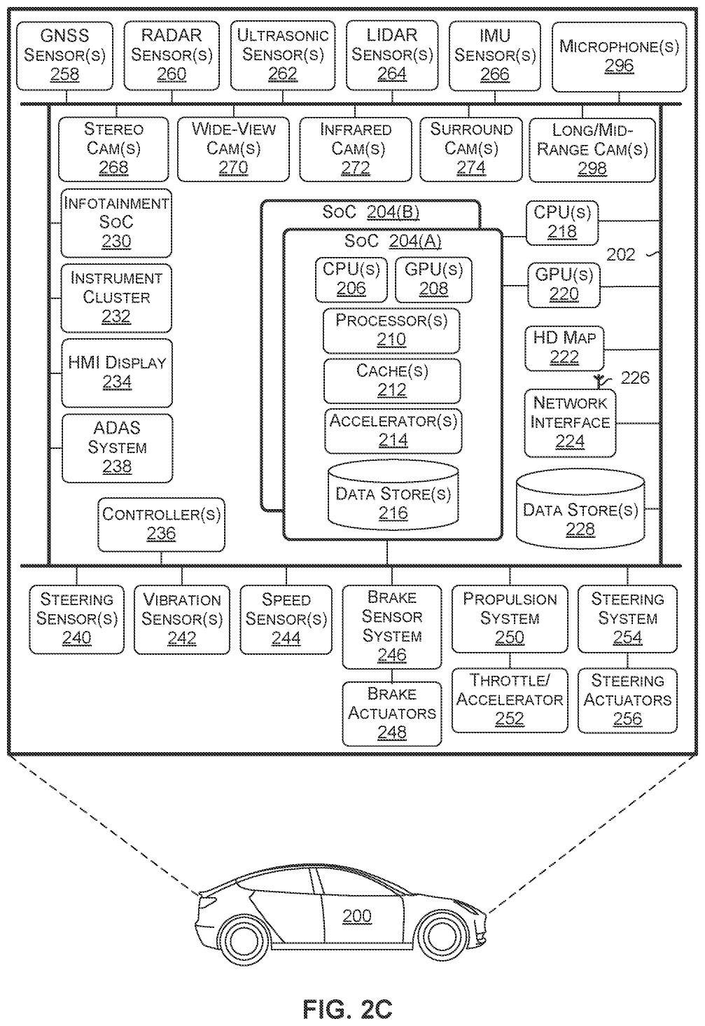

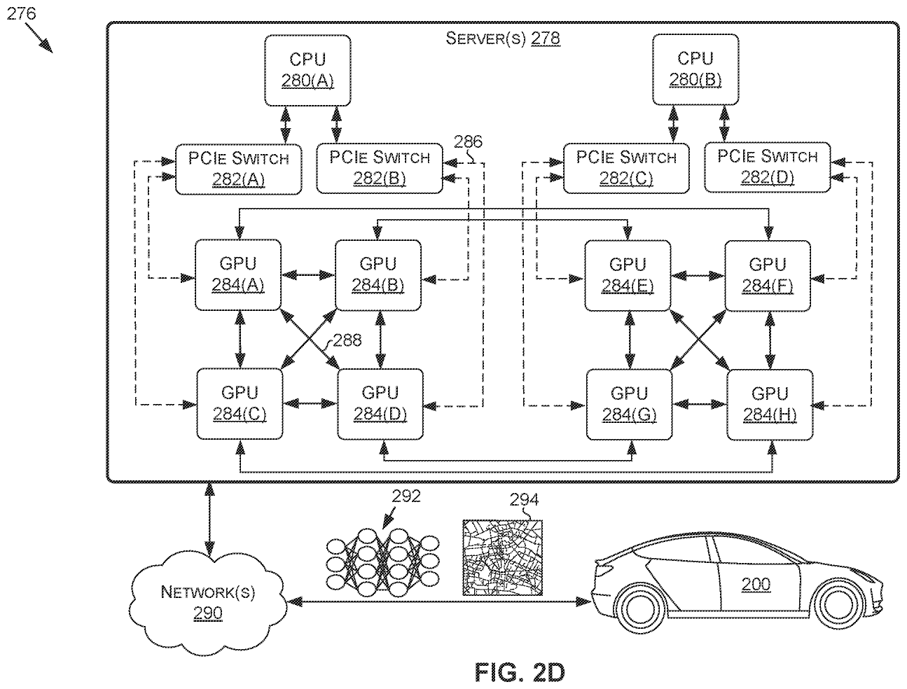

In some embodiments, the computing system 100 described herein can be executed using similar components, features, and/or functionality to those of example autonomous vehicle 200 of FIGS. 2A-2D. The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Autonomous Vehicle

FIG. 2A is an illustration of an exemplar autonomous vehicle 200, in accordance with some embodiments of the present disclosure. The autonomous vehicle 200 (alternatively referred to herein as the “vehicle 200”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 200 may be capable of functionality in accordance with one or more of Level 3-Level 5 of the autonomous driving levels. The vehicle 200 may be capable of functionality in accordance with one or more of Level 1-Level 5 of the autonomous driving levels. For example, the vehicle 200 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 200 or other machine, such as being fully autonomous, being highly autonomous, being conditionally autonomous, being partially autonomous, providing assistive autonomy, being semi-autonomous, being primarily autonomous, or other designation.

The vehicle 200 may include components such as a chassis, a vehicle body, wheels (e.g., 2, 4, 6, 8, 18, etc.), tires, axles, and other components of a vehicle. The vehicle 200 may include a propulsion system 250, such as an internal combustion engine, hybrid electric power plant, an all-electric engine, and/or another propulsion system type. The propulsion system 250 may be connected to a drive train of the vehicle 200, which may include a transmission, to enable the propulsion of the vehicle 200. The propulsion system 250 may be controlled in response to receiving signals from the throttle/accelerator 252.

A steering system 254, which may include a steering wheel, may be used to steer the vehicle 200 (e.g., along a desired path or route) when the propulsion system 250 is operating (e.g., when the vehicle is in motion). The steering system 254 may receive signals from a steering actuator 256. The steering wheel may be optional for full automation (Level 5) functionality.

The brake sensor system 246 may be used to operate the vehicle brakes in response to receiving signals from the brake actuators 248 and/or brake sensors.

Controller(s) 236, which may include one or more system on chips (SoCs) 204 (FIG. 2C) and/or GPU(s), may provide signals (e.g., representative of commands) to one or more components and/or systems of the vehicle 200. For example, the controller(s) may send signals to operate the vehicle brakes via one or more brake actuators 248, to operate the steering system 254 via one or more steering actuators 256, to operate the propulsion system 250 via one or more throttle/accelerators 252. The controller(s) 236 may include one or more onboard (e.g., integrated) computing devices (e.g., supercomputers) that process sensor signals, and output operation commands (e.g., signals representing commands) to enable autonomous driving and/or to assist a human driver in driving the vehicle 200. The controller(s) 236 may include a first controller 236 for autonomous driving functions, a second controller 236 for functional safety functions, a third controller 236 for artificial intelligence functionality (e.g., computer vision), a fourth controller 236 for infotainment functionality, a fifth controller 236 for redundancy in emergency conditions, and/or other controllers. In some examples, a single controller 236 may handle two or more of the above functionalities, two or more controllers 236 may handle a single functionality, and/or any combination thereof.

The controller(s) 236 may provide the signals for controlling one or more components and/or systems of the vehicle 200 in response to sensor data received from one or more sensors (e.g., sensor inputs). The sensor data may be received from, for example and without limitation, global navigation satellite systems (“GNSS”) sensor(s) 258 (e.g., Global Positioning System sensor(s)), RADAR sensor(s) 260, ultrasonic sensor(s) 262, LIDAR sensor(s) 264, inertial measurement unit (IMU) sensor(s) 266 (e.g., accelerometer(s), gyroscope(s), magnetic compass(es), magnetometer(s), etc.), microphone(s) 296, stereo camera(s) 268, wide-view camera(s) 270 (e.g., fisheye cameras), infrared camera(s) 272, surround camera(s) 274 (e.g., 360 degree cameras), long-range and/or mid-range camera(s) 298, speed sensor(s) 244 (e.g., for measuring the speed of the vehicle 200), vibration sensor(s) 242, steering sensor(s) 240, brake sensor(s) (e.g., as part of the brake sensor system 246), and/or other sensor types.

One or more of the controller(s) 236 may receive inputs (e.g., represented by input data) from an instrument cluster 232 of the vehicle 200 and provide outputs (e.g., represented by output data, display data, etc.) via a human-machine interface (HMI) display 234, an audible annunciator, a loudspeaker, and/or via other components of the vehicle 200. The outputs may include information such as vehicle velocity, speed, time, map data (e.g., the High Definition (“HD”) map 222 of FIG. 2C), location data (e.g., the vehicle's 200 location, such as on a map), direction, location of other vehicles (e.g., an occupancy grid), information about objects and status of objects as perceived by the controller(s) 236, etc. For example, the HMI display 234 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 200 further includes a network interface 224 which may use one or more wireless antenna(s) 226 and/or modem(s) to communicate over one or more networks. For example, the network interface 224 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 226 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 2B exemplar camera locations and fields of view for the exemplar autonomous vehicle 200 of FIG. 2A, in accordance with some embodiments of the present disclosure. The cameras and respective fields of view are one example embodiment and are not intended to be limiting. For example, additional and/or alternative cameras may be included and/or the cameras may be located at different locations on the vehicle 200.

The camera types for the cameras may include, but are not limited to, digital cameras that may be adapted for use with the components and/or systems of the vehicle 200. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 200 (e.g., front-facing cameras) may be used for surround view, to help identify forward facing paths and obstacles, as well aid in, with the help of one or more controllers 236 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 270 that may be used to perceive objects coming into view from the periphery (e.g., pedestrians, crossing traffic or bicycles). Although only one wide-view camera is illustrated in FIG. 2B, there may be any number (including zero) of wide-view cameras 270 on the vehicle 200. In addition, any number of long-range camera(s) 298 (e.g., a long-view stereo camera pair) may be used for depth-based object detection, especially for objects for which a neural network has not yet been trained. The long-range camera(s) 298 may also be used for object detection and classification, as well as basic object tracking.

Any number of stereo cameras 268 may also be included in a front-facing configuration. In some embodiments, one or more of stereo camera(s) 268 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 268 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 268 may be used in addition to, or alternatively from, those described herein.

Cameras with a field of view that include portions of the environment to the side of the vehicle 200 (e.g., side-view cameras) may be used for surround view, providing information used to create and update the occupancy grid, as well as to generate side impact collision warnings. For example, surround camera(s) 274 (e.g., four surround cameras 274 as illustrated in FIG. 2B) may be positioned to on the vehicle 200. The surround camera(s) 274 may include wide-view camera(s) 270, fisheye camera(s), 360 degree camera(s), and/or the like. Four example, four fisheye cameras may be positioned on the vehicle's front, rear, and sides. In an alternative arrangement, the vehicle may use three surround camera(s) 274 (e.g., left, right, and rear), and may leverage one or more other camera(s) (e.g., a forward-facing camera) as a fourth surround view camera.

Cameras with a field of view that include portions of the environment to the rear of the vehicle 200 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 298, stereo camera(s) 268), infrared camera(s) 272, etc.), as described herein.

FIG. 2C is a block diagram of an exemplar system architecture for the exemplar autonomous vehicle 200 of FIG. 2A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 200 in FIG. 2C are illustrated as being connected via bus 202. The bus 202 may include a Controller Area Network (CAN) data interface (alternatively referred to herein as a “CAN bus”). A CAN may be a network inside the vehicle 200 used to aid in control of various features and functionality of the vehicle 200, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 202 is described herein as being a CAN bus, this is not intended to be limiting. For example, in addition to, or alternatively from, the CAN bus, FlexRay and/or Ethernet may be used. Additionally, although a single line is used to represent the bus 202, this is not intended to be limiting. For example, there may be any number of busses 202, which may include one or more CAN busses, one or more FlexRay busses, one or more Ethernet busses, and/or one or more other types of busses using a different protocol. In some examples, two or more busses 202 may be used to perform different functions, and/or may be used for redundancy. For example, a first bus 202 may be used for collision avoidance functionality and a second bus 202 may be used for actuation control. In any example, each bus 202 may communicate with any of the components of the vehicle 200, and two or more busses 202 may communicate with the same components. In some examples, each SoC 204, each controller 236, and/or each computer within the vehicle may have access to the same input data (e.g., inputs from sensors of the vehicle 200), and may be connected to a common bus, such the CAN bus.

The vehicle 200 may include one or more controller(s) 236, such as those described herein with respect to FIG. 2A. The controller(s) 236 may be used for a variety of functions. The controller(s) 236 may be coupled to any of the various other components and systems of the vehicle 200, and may be used for control of the vehicle 200, artificial intelligence of the vehicle 200, infotainment for the vehicle 200, and/or the like.

The vehicle 200 may include a system(s) on a chip (SoC) 204. The SoC 204 may include CPU(s) 206, GPU(s) 208, processor(s) 210, cache(s) 212, accelerator(s) 214, data store(s) 216, and/or other components and features not illustrated. In some embodiments, components (e.g., CPU(s) 210 and data store(s) 216) included in the vehicle 200 can be the same as, or similar to, corresponding components (e.g., processor(s) 122 and memory(ies) 124) included in the computing system 100, described above in conjunction with FIG. 1. The SoC(s) 204 may be used to control the vehicle 200 in a variety of platforms and systems. For example, the SoC(s) 204 may be combined in a system (e.g., the system of the vehicle 200) with an HD map 222 which may obtain map refreshes and/or updates via a network interface 224 from one or more servers (e.g., server(s) 278 of FIG. 2D).

The CPU(s) 206 may include a CPU cluster or CPU complex (alternatively referred to herein as a “CCPLEX”). The CPU(s) 206 may include multiple cores and/or L2 caches. For example, in some embodiments, the CPU(s) 206 may include eight cores in a coherent multi-processor configuration. In some embodiments, the CPU(s) 206 may include four dual-core clusters where each cluster has a dedicated L2 cache (e.g., a 2 MB L2 cache). The CPU(s) 206 (e.g., the CCPLEX) may be configured to support simultaneous cluster operation enabling any combination of the clusters of the CPU(s) 206 to be active at any given time.

The CPU(s) 206 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 206 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 208 may include an integrated GPU (alternatively referred to herein as an “iGPU”). The GPU(s) 208 may be programmable and may be efficient for parallel workloads. The GPU(s) 208, in some examples, may use an enhanced tensor instruction set. The GPU(s) 208 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 208 may include at least eight streaming microprocessors. The GPU(s) 208 may use compute application programming interface(s) (API(s)). In addition, the GPU(s) 208 may use one or more parallel computing platforms and/or programming models (e.g., NVIDIA's CUDA).

The GPU(s) 208 may be power-optimized for best performance in automotive and embedded use cases. For example, the GPU(s) 208 may be fabricated on a Fin field-effect transistor (FinFET). However, this is not intended to be limiting and the GPU(s) 208 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 208 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 208 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 208 to access the CPU(s) 206 page tables directly. In such examples, when the GPU(s) 208 memory management unit (MMU) experiences a miss, an address translation request may be transmitted to the CPU(s) 206. In response, the CPU(s) 206 may look in its page tables for the virtual-to-physical mapping for the address and transmits the translation back to the GPU(s) 208. As such, unified memory technology may allow a single unified virtual address space for memory of both the CPU(s) 206 and the GPU(s) 208, thereby simplifying the GPU(s) 208 programming and porting of applications to the GPU(s) 208.

In addition, the GPU(s) 208 may include an access counter that may keep track of the frequency of access of the GPU(s) 208 to memory of other processors. The access counter may help ensure that memory pages are moved to the physical memory of the processor that is accessing the pages most frequently.

The SoC(s) 204 may include any number of cache(s) 212, including those described herein. For example, the cache(s) 212 may include an L3 cache that is available to both the CPU(s) 206 and the GPU(s) 208 (e.g., that is connected both the CPU(s) 206 and the GPU(s) 208). The cache(s) 212 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 204 may include an arithmetic logic unit(s) (ALU(s)) which may be leveraged in performing processing with respect to any of the variety of tasks or operations of the vehicle 200—such as processing DNNs. In addition, the SoC(s) 204 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 206 and/or GPU(s) 208.

The SoC(s) 204 may include one or more accelerators 214 (e.g., hardware accelerators, software accelerators, or a combination thereof). For example, the SoC(s) 204 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 208 and to off-load some of the tasks of the GPU(s) 208 (e.g., to free up more cycles of the GPU(s) 208 for performing other tasks). As an example, the accelerator(s) 214 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 214 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 208, and by using an inference accelerator, for example, a designer may target either the DLA(s) or the GPU(s) 208 for any function. For example, the designer may focus processing of CNNs and floating point operations on the DLA(s) and leave other functions to the GPU(s) 208 and/or other accelerator(s) 214.

The accelerator(s) 214 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 206. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 214 (e.g., the hardware acceleration cluster) may include a computer vision network on-chip and SRAM, for providing a high-bandwidth, low latency SRAM for the accelerator(s) 214. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 204 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 214 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 266 output that correlates with the vehicle 200 orientation, distance, 3D location estimates of the object obtained from the neural network and/or other sensors (e.g., LIDAR sensor(s) 264 or RADAR sensor(s) 260), among others.

The SoC(s) 204 may include data store(s) 216 (e.g., memory). The data store(s) 216 may be on-chip memory of the SoC(s) 204, which may store neural networks to be executed on the GPU and/or the DLA. In some examples, the data store(s) 216 may be large enough in capacity to store multiple instances of neural networks for redundancy and safety. The data store(s) 212 may comprise L2 or L3 cache(s) 212. Reference to the data store(s) 216 may include reference to the memory associated with the PVA, DLA, and/or other accelerator(s) 214, as described herein.

The SoC(s) 204 may include one or more processor(s) 210 (e.g., embedded processors). The processor(s) 210 may include a boot and power management processor that may be a dedicated processor and subsystem to handle boot power and management functions and related security enforcement. The boot and power management processor may be a part of the SoC(s) 204 boot sequence and may provide runtime power management services. The boot power and management processor may provide clock and voltage programming, assistance in system low power state transitions, management of SoC(s) 204 thermals and temperature sensors, and/or management of the SoC(s) 204 power states. Each temperature sensor may be implemented as a ring-oscillator whose output frequency is proportional to temperature, and the SoC(s) 204 may use the ring-oscillators to detect temperatures of the CPU(s) 206, GPU(s) 208, and/or accelerator(s) 214. If temperatures are determined to exceed a threshold, the boot and power management processor may enter a temperature fault routine and put the SoC(s) 204 into a lower power state and/or put the vehicle 200 into a chauffeur to safe stop mode (e.g., bring the vehicle 200 to a safe stop).

The processor(s) 210 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 210 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 210 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 210 may further include a real-time camera engine that may include a dedicated processor subsystem for handling real-time camera management.

The processor(s) 210 may further include a high-dynamic range signal processor that may include an image signal processor that is a hardware engine that is part of the camera processing pipeline.

The processor(s) 210 may include a video image compositor that may be a processing block (e.g., implemented on a microprocessor) that implements video post-processing functions needed by a video playback application to produce the final image for the player window. The video image compositor may perform lens distortion correction on wide-view camera(s) 270, surround camera(s) 274, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 208 is not required to continuously render new surfaces. Even when the GPU(s) 208 is powered on and active doing 3D rendering, the video image compositor may be used to offload the GPU(s) 208 to improve performance and responsiveness.

The SoC(s) 204 may further include a mobile industry processor interface (MIPI) camera serial interface for receiving video and input from cameras, a high-speed interface, and/or a video input block that may be used for camera and related pixel input functions. The SoC(s) 204 may further include an input/output controller(s) that may be controlled by software and may be used for receiving I/O signals that are uncommitted to a specific role.

The SoC(s) 204 may further include a broad range of peripheral interfaces to enable communication with peripherals, audio codecs, power management, and/or other devices. The SoC(s) 204 may be used to process data from cameras (e.g., connected over Gigabit Multimedia Serial Link and Ethernet), sensors (e.g., LIDAR sensor(s) 264, RADAR sensor(s) 260, etc. that may be connected over Ethernet), data from bus 202 (e.g., speed of vehicle 200, steering wheel position, etc.), data from GNSS sensor(s) 258 (e.g., connected over Ethernet or CAN bus). The SoC(s) 204 may further include dedicated high-performance mass storage controllers that may include their own DMA engines, and that may be used to free the CPU(s) 206 from routine data management tasks.

The SoC(s) 204 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 204 may be faster, more reliable, and even more energy-efficient and space-efficient than conventional systems. For example, the accelerator(s) 214, when combined with the CPU(s) 206, the GPU(s) 208, and the data store(s) 216, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 220) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 208.

In some examples, a CNN for facial recognition and vehicle owner identification may use data from camera sensors to identify the presence of an authorized driver and/or owner of the vehicle 200. The always on sensor processing engine may be used to unlock the vehicle when the owner approaches the driver door and turn on the lights, and, in security mode, to disable the vehicle when the owner leaves the vehicle. In this way, the SoC(s) 204 provide for security against theft and/or carjacking.

In another example, a CNN for emergency vehicle detection and identification may use data from microphones 296 to detect and identify emergency vehicle sirens. In contrast to conventional systems, that use general classifiers to detect sirens and manually extract features, the SoC(s) 204 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 258. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 262, until the emergency vehicle(s) passes.

The vehicle may include a CPU(s) 218 (e.g., discrete CPU(s), or dCPU(s)), that may be coupled to the SoC(s) 204 via a high-speed interconnect (e.g., PCIe). The CPU(s) 218 may include an X86 processor, for example. The CPU(s) 218 may be used to perform any of a variety of functions, including arbitrating potentially inconsistent results between ADAS sensors and the SoC(s) 204, and/or monitoring the status and health of the controller(s) 236 and/or infotainment SoC 230, for example.

The vehicle 200 may include a GPU(s) 220 (e.g., discrete GPU(s), or dGPU(s)), that may be coupled to the SoC(s) 204 via a high-speed interconnect (e.g., NVIDIA's NVLINK). The GPU(s) 220 may provide additional artificial intelligence functionality, such as by executing redundant and/or different neural networks, and may be used to train and/or update neural networks based on input (e.g., sensor data) from sensors of the vehicle 200.

The vehicle 200 may further include the network interface 224 which may include one or more wireless antennas 226 (e.g., one or more wireless antennas for different communication protocols, such as a cellular antenna, a Bluetooth antenna, etc.). The network interface 224 may be used to enable wireless connectivity over the Internet with the cloud (e.g., with the server(s) 278 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 200 information about vehicles in proximity to the vehicle 200 (e.g., vehicles in front of, on the side of, and/or behind the vehicle 200). This functionality may be part of a cooperative adaptive cruise control functionality of the vehicle 200.

The network interface 224 may include a SoC that provides modulation and demodulation functionality and enables the controller(s) 236 to communicate over wireless networks. The network interface 224 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 200 may further include data store(s) 228 which may include off-chip (e.g., off the SoC(s) 204) storage. The data store(s) 228 may include one or more storage elements including RAM, SRAM, DRAM, VRAM, Flash, hard disks, and/or other components and/or devices that may store at least one bit of data.

The vehicle 200 may further include GNSS sensor(s) 258. The GNSS sensor(s) 258 (e.g., GPS, assisted GPS sensors, differential GPS (DGPS) sensors, etc.), to assist in mapping, perception, occupancy grid generation, and/or path planning functions. Any number of GNSS sensor(s) 258 may be used, including, for example and without limitation, a GPS using a USB connector with an Ethernet to Serial (RS-232) bridge.

The vehicle 200 may further include RADAR sensor(s) 260. The RADAR sensor(s) 260 may be used by the vehicle 200 for long-range vehicle detection, even in darkness and/or severe weather conditions. RADAR functional safety levels may be ASIL B. The RADAR sensor(s) 260 may use the CAN and/or the bus 202 (e.g., to transmit data generated by the RADAR sensor(s) 260) for control and to access object tracking data, with access to Ethernet to access raw data in some examples. A wide variety of RADAR sensor types may be used. For example, and without limitation, the RADAR sensor(s) 260 may be suitable for front, rear, and side RADAR use. In some example, Pulse Doppler RADAR sensor(s) are used.

The RADAR sensor(s) 260 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 260 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 200 surroundings at higher speeds with minimal interference from traffic in adjacent lanes. The other two antennae may expand the field of view, making it possible to quickly detect vehicles entering or leaving the vehicle's 200 lane.

Mid-range RADAR systems may include, as an example, a range of up to 260 m (front) or 80 m (rear), and a field of view of up to 42 degrees (front) or 250 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 200 may further include ultrasonic sensor(s) 262. The ultrasonic sensor(s) 262, which may be positioned at the front, back, and/or the sides of the vehicle 200, may be used for park assist and/or to create and update an occupancy grid. A wide variety of ultrasonic sensor(s) 262 may be used, and different ultrasonic sensor(s) 262 may be used for different ranges of detection (e.g., 2.5 m, 4 m). The ultrasonic sensor(s) 262 may operate at functional safety levels of ASIL B.

The vehicle 200 may include LIDAR sensor(s) 264. The LIDAR sensor(s) 264 may be used for object and pedestrian detection, emergency braking, collision avoidance, and/or other functions. The LIDAR sensor(s) 264 may be functional safety level ASIL B. In some examples, the vehicle 200 may include multiple LIDAR sensors 264 (e.g., two, four, six, etc.) that may use Ethernet (e.g., to provide data to a Gigabit Ethernet switch).

In some examples, the LIDAR sensor(s) 264 may be capable of providing a list of objects and their distances for a 360-degree field of view. Commercially available LIDAR sensor(s) 264 may have an advertised range of approximately 200 m, with an accuracy of 2 cm-3 cm, and with support for a 200 Mbps Ethernet connection, for example. In some examples, one or more non-protruding LIDAR sensors 264 may be used. In such examples, the LIDAR sensor(s) 264 may be implemented as a small device that may be embedded into the front, rear, sides, and/or corners of the vehicle 200. The LIDAR sensor(s) 264, in such examples, may provide up to a 120-degree horizontal and 35-degree vertical field-of-view, with a 200 m range even for low-reflectivity objects. Front-mounted LIDAR sensor(s) 264 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 200. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 264 may be less susceptible to motion blur, vibration, and/or shock.

The vehicle may further include IMU sensor(s) 266. The IMU sensor(s) 266 may be located at a center of the rear axle of the vehicle 200, in some examples. The IMU sensor(s) 266 may include, for example and without limitation, an accelerometer(s), a magnetometer(s), a gyroscope(s), a magnetic compass(es), and/or other sensor types. In some examples, such as in six-axis applications, the IMU sensor(s) 266 may include accelerometers and gyroscopes, while in nine-axis applications, the IMU sensor(s) 266 may include accelerometers, gyroscopes, and magnetometers.

In some embodiments, the IMU sensor(s) 266 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 266 may enable the vehicle 200 to estimate heading without requiring input from a magnetic sensor by directly observing and correlating the changes in velocity from GPS to the IMU sensor(s) 266. In some examples, the IMU sensor(s) 266 and the GNSS sensor(s) 258 may be combined in a single integrated unit.

The vehicle may include microphone(s) 296 placed in and/or around the vehicle 200. The microphone(s) 296 may be used for emergency vehicle detection and identification, among other things.

The vehicle may further include any number of camera types, including stereo camera(s) 268, wide-view camera(s) 270, infrared camera(s) 272, surround camera(s) 274, long-range and/or mid-range camera(s) 298, and/or other camera types. The cameras may be used to capture image data around an entire periphery of the vehicle 200. The types of cameras used depends on the embodiments and requirements for the vehicle 200, and any combination of camera types may be used to provide the necessary coverage around the vehicle 200. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 2A and FIG. 2B.

The vehicle 200 may further include vibration sensor(s) 242. The vibration sensor(s) 242 may measure vibrations of components of the vehicle, such as the axle(s). For example, changes in vibrations may indicate a change in road surfaces. In another example, when two or more vibration sensors 242 are used, the differences between the vibrations may be used to determine friction or slippage of the road surface (e.g., when the difference in vibration is between a power-driven axle and a freely rotating axle).

The vehicle 200 may include an ADAS system 238. The ADAS system 238 may include a SoC, in some examples. The ADAS system 238 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 260, LIDAR sensor(s) 264, and/or a camera(s). The ACC systems may include longitudinal ACC and/or lateral ACC. Longitudinal ACC monitors and controls the distance to the vehicle immediately ahead of the vehicle 200 and automatically adjust the vehicle speed to maintain a safe distance from vehicles ahead. Lateral ACC performs distance keeping, and advises the vehicle 200 to change lanes when necessary. Lateral ACC is related to other ADAS applications such as LCA and CWS.

CACC uses information from other vehicles that may be received via the network interface 224 and/or the wireless antenna(s) 226 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 200), while the 12V communication concept provides information about traffic further ahead. CACC systems may include either or both 12V and V2V information sources. Given the information of the vehicles ahead of the vehicle 200, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 260, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 260, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 200 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 200 if the vehicle 200 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 260, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 200 is backing up. Some RCTW systems include AEB to ensure that the vehicle brakes are applied to avoid a crash. RCTW systems may use one or more rear-facing RADAR sensor(s) 260, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 200, the vehicle 200 itself must, in the case of conflicting results, decide whether to heed the result from a primary computer or a secondary computer (e.g., a first controller 236 or a second controller 236). For example, in some embodiments, the ADAS system 238 may be a backup and/or secondary computer for providing perception information to a backup computer rationality module. The backup computer rationality monitor may run a redundant diverse software on hardware components to detect faults in perception and dynamic driving tasks. Outputs from the ADAS system 238 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 204.

In other examples, ADAS system 238 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 238 may be fed into the primary computer's perception block and/or the primary computer's dynamic driving task block. For example, if the ADAS system 238 indicates a forward crash warning due to an object immediately ahead, the perception block may use this information when identifying objects. In other examples, the secondary computer may have its own neural network which is trained and thus reduces the risk of false positives, as described herein.

The vehicle 200 may further include the infotainment SoC 230 (e.g., an in-vehicle infotainment system (IVI)). Although illustrated and described as a SoC, the infotainment system may not be a SoC, and may include two or more discrete components. The infotainment SoC 230 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 200. For example, the infotainment SoC 230 may radios, disk players, navigation systems, video players, USB and Bluetooth connectivity, carputers, in-car entertainment, Wi-Fi, steering wheel audio controls, hands free voice control, a heads-up display (HUD), an HMI display 234, a telematics device, a control panel (e.g., for controlling and/or interacting with various components, features, and/or systems), and/or other components. The infotainment SoC 230 may further be used to provide information (e.g., visual and/or audible) to a user(s) of the vehicle, such as information from the ADAS system 238, autonomous driving information such as planned vehicle maneuvers, trajectories, surrounding environment information (e.g., intersection information, vehicle information, road information, etc.), and/or other information.

The infotainment SoC 230 may include GPU functionality. The infotainment SoC 230 may communicate over the bus 202 (e.g., CAN bus, Ethernet, etc.) with other devices, systems, and/or components of the vehicle 200. In some examples, the infotainment SoC 230 may be coupled to a supervisory MCU such that the GPU of the infotainment system may perform some self-driving functions in the event that the primary controller(s) 236 (e.g., the primary and/or backup computers of the vehicle 200) fail. In such an example, the infotainment SoC 230 may put the vehicle 200 into a chauffeur to safe stop mode, as described herein.

The vehicle 200 may further include an instrument cluster 232 (e.g., a digital dash, an electronic instrument cluster, a digital instrument panel, etc.). The instrument cluster 232 may include a controller and/or supercomputer (e.g., a discrete controller or supercomputer). The instrument cluster 232 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 230 and the instrument cluster 232. In other words, the instrument cluster 232 may be included as part of the infotainment SoC 230, or vice versa.

FIG. 2D is a system diagram for communication between cloud-based server(s) and the exemplar autonomous vehicle 200 of FIG. 2A, in accordance with some embodiments of the present disclosure. The system 276 may include server(s) 278, network(s) 290, and vehicles, including the vehicle 200. The server(s) 278 may include a plurality of GPUs 284(A)-284(H) (collectively referred to herein as GPUs 284), PCIe switches 282(A)-282(H) (collectively referred to herein as PCIe switches 282), and/or CPUs 280(A)-280(B) (collectively referred to herein as CPUs 280). The GPUs 284, the CPUs 280, and the PCIe switches may be interconnected with high-speed interconnects such as, for example and without limitation, NVLink interfaces 288 developed by NVIDIA and/or PCIe connections 286. In some examples, the GPUs 284 are connected via NVLink and/or NVSwitch SoC and the GPUs 284 and the PCIe switches 282 are connected via PCIe interconnects. Although eight GPUs 284, two CPUs 280, and two PCIe switches are illustrated, this is not intended to be limiting. Depending on the embodiment, each of the server(s) 278 may include any number of GPUs 284, CPUs 280, and/or PCIe switches. For example, the server(s) 278 may each include eight, sixteen, thirty-two, and/or more GPUs 284.

The server(s) 278 may receive, over the network(s) 290 and from the vehicles, image data representative of images showing unexpected or changed road conditions, such as recently commenced road-work. The server(s) 278 may transmit, over the network(s) 290 and to the vehicles, neural networks 292, updated neural networks 292, and/or map information 294, including information regarding traffic and road conditions. The updates to the map information 294 may include updates for the HD map 222, such as information regarding construction sites, potholes, detours, flooding, and/or other obstructions. In some examples, the neural networks 292, the updated neural networks 292, and/or the map information 294 may have resulted from new training and/or experiences represented in data received from any number of vehicles in the environment, and/or based on training performed at a datacenter (e.g., using the server(s) 278 and/or other servers).

The server(s) 278 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 290, and/or the machine learning models may be used by the server(s) 278 to remotely monitor the vehicles.

In some examples, the server(s) 278 may receive data from the vehicles and apply the data to up-to-date real-time neural networks for real-time intelligent inferencing. The server(s) 278 may include deep-learning supercomputers and/or dedicated AI computers powered by GPU(s) 284, such as a DGX and DGX Station machines developed by NVIDIA. However, in some examples, the server(s) 278 may include deep learning infrastructure that use only CPU-powered datacenters.

The deep-learning infrastructure of the server(s) 278 may be capable of fast, real-time inferencing, and may use that capability to evaluate and verify the health of the processors, software, and/or associated hardware in vehicle 200. For example, the deep-learning infrastructure may receive periodic updates from the vehicle 200, such as a sequence of images and/or objects that the vehicle 200 has located in that sequence of images (e.g., via computer vision and/or other machine learning object classification techniques). The deep-learning infrastructure may run its own neural network to identify the objects and compare them with the objects identified by the vehicle 200 and, if the results do not match and the infrastructure concludes that the AI in the vehicle 200 is malfunctioning, the server(s) 278 may transmit a signal to the vehicle 200 instructing a fail-safe computer of the vehicle 200 to assume control, notify the passengers, and complete a safe parking maneuver.

For inferencing, the server(s) 278 may include the GPU(s) 284 and one or more programmable inference accelerators (e.g., NVIDIA's Tensor®). The combination of GPU-powered servers and inference acceleration may make real-time responsiveness possible. In other examples, such as where performance is less critical, servers powered by CPUs, FPGAs, and other processors may be used for inferencing.

### Combining Learning-Based and Rule-Based Model Predictions

FIG. 3 is a more detailed illustration of the prediction application 126 of FIG. 1, according to various embodiments. As shown, prediction application 126 includes, without limitation, a set of hyperparameters 301, a rule-based prediction model 302, a learning-based prediction model 303, a belief update module 304, and a prediction fusion module 305. In operation, prediction application 126 generates predictions by combining, also referred to herein as “fusing,” predictions made using rule-based prediction model 302 and learning-based prediction model 303 based on a belief about the accuracy of each model 302 and 303, and the belief is updated (by belief update module 304) over time based on observed environment states.

Hyperparameters 301 are adjustable parameters of the prediction fusion technique described herein. In some embodiments, hyperparameters 301 includes the number of outcome samples per scene N, which determines how many potential future predictions the prediction application 126 will consider for each observation of an environment. N affects the thoroughness with which possible outcomes are evaluated. A higher number of prediction samples N increases the likelihood of capturing a wider range of future scenarios. However, a higher number of prediction samples N also requires more computational resources and can slow down the decision-making process. In some embodiments, hyperparameters 301 also includes a prediction horizon T that defines the time frame over which the prediction application makes predictions. A longer prediction horizon allows the prediction application 126 to plan further into the future, which can be beneficial for strategic decision-making, such as route planning. However, the further the horizon, the greater the uncertainty, as predictions become less reliable with increased time due to the chaotic nature of some environments. In some embodiments, hyperparameters 301 also includes the Bayes learning rate n, which controls the rate at which belief update module 304 updates the beliefs about whether rule-based prediction model 302 or learning-based prediction model 303 is more reliable. A higher learning rate means belief update module 304 will quickly adjust the beliefs in response to new data, which is useful in rapidly changing environments. On the other hand, a lower rate means belief update module 304 will be more conservative in changing the beliefs, which can prevent overfitting to recent data that may not represent long-term trends. In some embodiments, hyperparameters 301 also includes the convex combination factor with prior γ and the belief prior b₀, which influence the initial state and the update mechanism of the belief distribution. The combination factor γ determines how much weight is given to new data versus a prior belief. A high value of γ can make the prediction fusion application 126 more responsive to new observations, while a low value of γ puts more trust in the accumulated knowledge. The belief prior b₀ sets the initial belief state before any data is observed, serving as a starting point for the belief update process. For example, in some embodiments, b₀ can be chosen as (0.5,0.5) initially, giving equal confidence to predictions made by rule-based prediction model 302 and by learning-based prediction model 303.

Rule-based prediction model 302 generates predictions according to a predefined set of rules. In some embodiments, rule-based prediction model 302 provides a structured approach to predicting actions by an agent, such as a vehicle. Although described herein primarily with respect to predicting the actions of an agent that is a vehicle as a reference example, techniques disclosed herein can be applied to generate any technically feasible predictions for which observations can be made to update a belief used to generate future predictions. Further, although described herein primarily with respect to predicting the action of one agent, techniques disclosed herein can be repeated to predict the actions of multiple agents, or techniques disclosed herein can be modified to simultaneously predict the actions of multiple agents. Rule-based prediction model 302 operates on the assumption that agents, whether humans or autonomous systems, will act in accordance with a set of rules, which can range from simple heuristics to complex codifications of norms, such as maintaining a lane or following traffic signals in the case of a vehicle. In various embodiments, rule-based prediction model 302 includes a hierarchy of rules, which allows for nuanced interpretations of situations, assigning different weights to various rules based on the corresponding importance. The hierarchy of rules, denoted herein by ϕ:={ϕᵢ}ᵢ₌₁ⁿ, induces a ranking system for potential outcomes, and the robustness vector ρ∈ [symbol] ⁿ represents the individual robustness of each rule ϕᵢ. Consequently, outcomes that conform to more crucial rules are assigned a higher rank. For example, for a two-rule hierarchy {ϕᵢ}ᵢ₌₁² in an autonomous vehicle trajectory prediction system, the ranking can be as follows: trajectories satisfying both rules receive the highest rank, trajectories adhering to a more critical rule ϕ₁ but not a less critical rule ϕ₂ are ranked second, trajectories that satisfy the less critical rule ϕ₂ but not the more critical rule ϕ₁ are third, and trajectories violating both rules are ranked lowest. The hierarchy of rules permits less critical rules to be momentarily overlooked while strictly observing more critical rules, which introduces a degree of flexibility for handling multifaceted scenarios. For example, in the context of an autonomous vehicle, rule-based prediction model 302 can encode behaviors such as stopping at stop signs, yielding to pedestrians, staying within speed limits, executing safe lane changes, and/or the like. In some embodiments, rule-based prediction model 302 includes rules that enforce physical constraints, ensuring that an agent operates within the bounds of capabilities of the agent, and semantic rules that capture the essence of norms, such as allowing for safe overtaking and merging behaviors in the case of a vehicle.

In various embodiments, the predictions of the rule-based prediction model 302 include Boolean expressions, and robustness metrics quantify the degree to which each rule is satisfied. For example, in a hierarchy of rules, rules can be expressed as Boolean expressions ϕ:X×Y×M→{True, False}}, where x∈X denotes the state of the agent for which predictions are made, y∈Y denotes the joint state of all agents in the scene, and m denotes the scene map which belongs to feature map space M. In various embodiment, X and Y can also denote the spaces that x_{t:t+τ} and y_{t:t+τ}, which are the discrete-time states over some time duration τ from t to t+τ, belong to, respectively. The robustness metrics ρ:X×Y×M→ [symbol] return positive values when rules are met, with larger values indicating higher fidelity to the rules and negative values indicating rule violations, with more negative numbers indicating more significant rule violations. The feedback in terms of metric values assists in assessing the quality of the predictions by the rule-based prediction model 302, and the rules in the rule-based prediction model 302 can be refined for better accuracy based on the metric values.

In some embodiments, rules in the rule-based prediction model 302 are expressed in formal logic, such as Signal Temporal Logic (STL) and/or the like, allowing for precise definition and evaluation of behaviors. Each rule within the hierarchy has a defined robustness metric p, which quantitatively measures the degree of rule satisfaction, enabling a ranking system for possible outcomes, such as a ranking of trajectories a vehicle might take. Outcomes that satisfy more important rules are ranked higher than outcomes that meet less important rules. The ranking guides the decision-making process, especially in complex decision-making scenarios where multiple rules can come into play simultaneously. For example, the rules for predicting a vehicle trajectory can prioritize avoiding a collision over maintaining lane integrity, reflecting a human-like assessment of priorities. As a specific example, the hierarchy of rules for predicting a vehicle trajectory can include four rules in decreasing importance: collision avoidance, follow the center polyline of a lane to be followed, orient along the center polyline of the lane to be followed, and follow the speed limit.

Returning to the vehicle example, in some embodiments, an autonomous vehicle can include a rule-based prediction model (e.g., rule-based prediction model 302) that first chooses the nearest lane to another vehicle (e.g., in terms of the Cartesian distance as well as the orientation) as the lane for the other vehicle to follow and uses a rule hierarchy that includes the following rules in order of decreasing importance: a collision avoidance rule, a rule to follow the center polyline of a lane to be followed, a rule to orient along the center polyline of the lane to be followed, and a rule to follow the speed limit. In such a case, the rule-based prediction model can trajectories with the highest possible rank, which are defined by, for example, a rank-preserving reward function R:ρ [symbol] R(ρ)∈ [symbol] of a rule hierarchy that embodies the property that trajectories with a higher rank receive a higher reward than trajectories with a lower rank. For example, the following rank-preserving reward function could be used:

$$R ( ρ ) = {\sum }_{i = 1}^{n} ( {a}^{n - i + 1} step ( {ρ}_{i} ) + \frac{1}{n} {ρ}_{i} ) , \qquad ( 1 )$$

where α>2. The rule-based prediction model then generates a trajectory tree with K branches {x_{t+1,:t+T}¹, . . . , x_{t+1:t+T}^{K}}, for example, using splines, and computes the rank-preserving rewards {R₁, . . . , R_{K}} for each trajectory. In some embodiments, the rule-based prediction model carries out trajectory tree generation and reward computation in parallel on one or more GPUs. In some embodiments, rather than choosing the trajectory with the highest reward, the rule-based prediction model 302, denoted by r, transforms the trajectory tree to a discrete Boltzmann distribution P(x_{t+1:t+T}|y_{t-H:t}, m, r), defined over potential future outcomes x_{t+1:t+T}, given a historical context y_{t-H:t} and a scene map described by a vector m within the feature space M, by viewing the rewards as the negative of the Boltzmann energy as follows:

$${p}_{i} = \frac{exp ( {R}_{i} / ζ )}{{\sum }_{i = 1}^{K} exp ( {R}_{i} / ζ )} , \qquad ( 2 )$$

where ζ>0 is the temperature of the Boltzmann distribution, controlling the degree of optimality expected from real-world agents (e.g., vehicles) with respect to a chosen rule hierarchy.

Learning-based prediction model 303 is a machine learning model that is trained to generate predictions. Any technically feasible machine learning model can be used in some embodiments. In some embodiments, learning-based prediction model 303, denoted by l, can be a generative network that produces a probability distribution P(x_{t+1:t+T}|y_{t-H:t}, m, l). The generative network can include, but is not limited, to deep learning architectures, such as like recurrent neural networks (RNNs), transformers, and/or the like, which encode temporal sequences, enabling learning-based prediction model 303 to extrapolate the future states of agents from past data. In some embodiments, learning-based prediction model 303 considers a range of possible future outcomes. For example, in the context of predicting vehicle behaviors, learning-based prediction model 303 can produce a diverse set of vehicle trajectory samples {x_{t+1:t+T}ⁱ}ᵢ₌₁^{N} that are drawn from a predicted distribution, reflecting the probabilistic nature of driving behaviors. In such cases, learning-based prediction model 303 can also assign to each trajectory a likelihood based on how well the trajectory aligns with observed data and known physical constraints.

In various embodiments, learning-based prediction model 303 includes contextual cues, which ensures that predictions generated by learning-based prediction module 303 are not only based on the historical outcomes of agents but also on the environment in which the agents operate. For example, by conditioning on contextual information, such as the lane geometry and the semantic map information, learning-based prediction models 303 can enhance the trajectory predictions for a vehicle. In some embodiments, learning-based prediction model 303 can leverage the comprehensive map vector m to incorporate the layout of roads, positions of traffic lights, and pedestrian crossings into the trajectory planning. The scene map, encoded by a map vector m of map features, enriches the input to learning-based prediction model 303, enabling a nuanced understanding of the driving context.

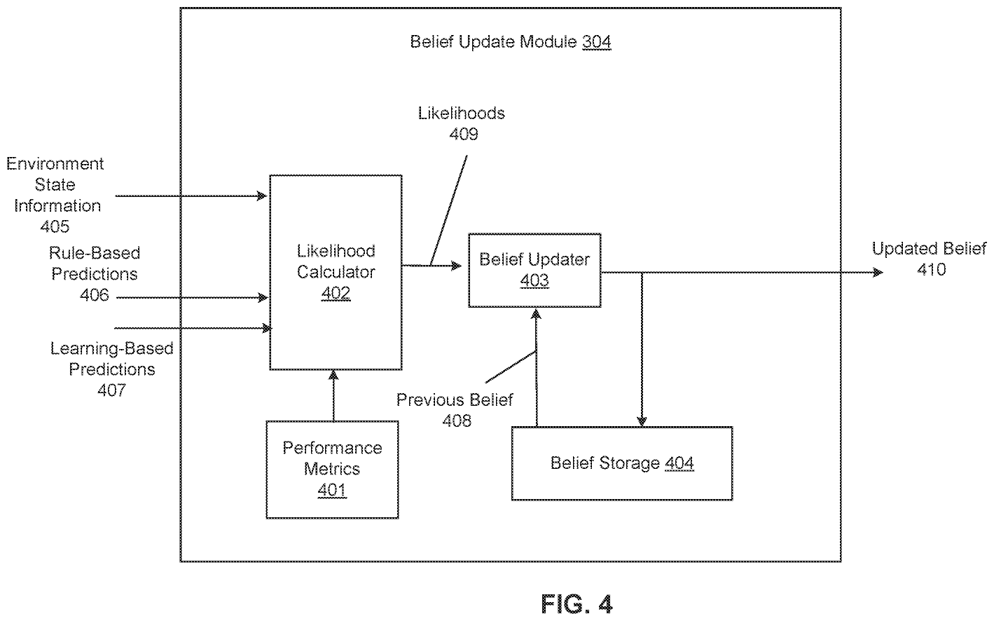

Belief update module 304 processes new environment state information 405 and predictions at a previous time step by rule-based prediction model 302 and predictions by learning-based prediction model 303 in order to update a belief in the confidence of predictions by rule-based prediction model 302 and learning-based prediction model 303. Returning to the vehicle example, environment state information 405 can include the position and movement of a vehicle (e.g., a historical vehicle trajectory) and a map of the environment indicating where lanes, traffic light, etc. are. In some embodiments, belief update module 304 implements a Bayesian updating principle, which uses a prior belief distribution to incorporate new evidence and adjust the confidence in the prediction outputs of both rule-based prediction model 302 and learning-based prediction model 303. Belief update module 304 takes the likelihood of the current observed state given the predictions by rule-based prediction model 302 and learning-based prediction model 303 at a previous time step and computes a belief ratio, which serves as the basis for updating the belief distribution. For example, if learning-based prediction model 303 consistently provides accurate predictions under certain conditions, the belief update module 304 will reflect a higher trust in learning-based prediction model 303 for similar future scenarios. Conversely, if the rule-based prediction model 302 excels in structured environments, such as well-defined traffic situations and/or the like, the belief distribution will be updated to favor the rule-based prediction model 302 in such contexts. The continuous recalibration ensures that the predictive capabilities of the prediction application 126 evolve with new agent observations, enhancing accuracy over time and allowing for more reliable decision-making in dynamic scenarios. Belief update module 304 is described in more detail below in conjunction with FIG. 4.

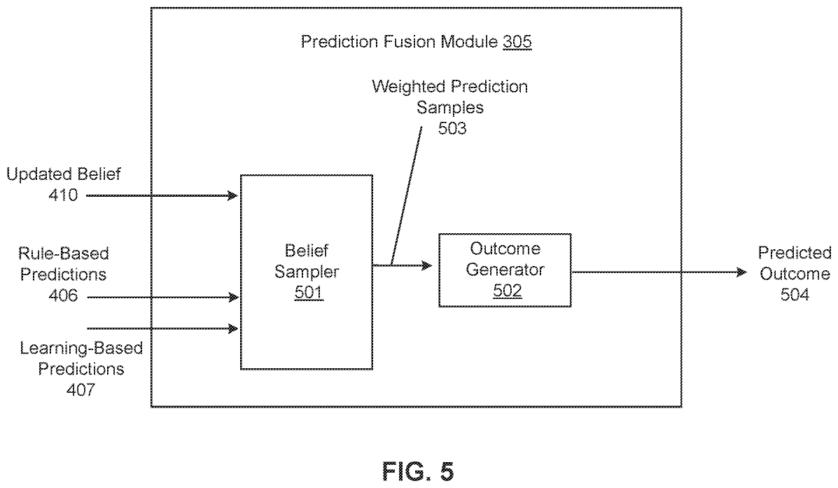

Prediction fusion module 305 processes the updated belief output by belief update module 304 and predictions output by rule-based prediction model 302 and by learning-based prediction model 303 to generate a predicted outcome. Using the updated belief distribution from belief update module 304, prediction fusion model 305 can employ a weighted approach to combine predictions by rule-based prediction model 302 and learning-based prediction model 303. In various embodiments, prediction fusion module 305 samples potential predicted outcomes from a distribution of predictions generated by rule-based prediction model 302 and a distribution of predictions generated by learning-based prediction model 303, weighing predicted outcomes according to the confidence levels indicated by the belief distribution. Prediction fusion module 305 is described in more detail below in conjunction with FIG. 5.

FIG. 4 is a more detailed illustration of the belief update module 304 of FIG. 3, according to various embodiments. As shown, belief update module 304 includes, without limitation, a performance metric module 401, a likelihood calculator 402, a belief updater 403, and a belief storage 404.

Performance metric module 401 stores a set of performance metrics defined by a function Γ: x^{N}×X→[0, ∞) which quantitatively evaluates (1) learning-based predictions 407 {x_{t+1,i}^{l}}ᵢ₌₁^{N} generated using learning-based prediction model 303, and (2) rule-based predictions 406 {x_{t+1,i}^{r})}ᵢ₌₁^{N} generated using rule-based prediction model 302, against the environment state information 405. The N here represents the number of prediction samples considered, which is stored in hyperparameters 301, and the function outputs a value indicating the degree of conformance between predicted and observed states, with higher values reflecting greater accuracy. In some embodiments, performance metric module 401 uses δ(x_{t+1,i}^{l}xₜ₊₁)=e^{-|x}^{_{t+1,i}}^{-x}^{ₜ₊₁}| for the rule-based prediction model 302 and the learning-based prediction model 303, where a higher exponential decay of the displacement error indicates better performance. In some embodiments, average displacement error (ADE) can be used as the performance metric. ADE is an average of the mean distance error across N predicted trajectories and the ground truth. In various embodiments, final displacement error (FDE) can be used as the performance metric. FDE is an average of the distance error between the last time step of N predicted trajectories and the last time-step of the ground truth future trajectory. In various embodiments, minADE can be used as the performance metric. minADE is the smallest mean distance error across N predicted trajectories and the ground truth future trajectory More generally, in some embodiments, any technically feasible performance metric(s), such as loss functions that are used to train learning-based prediction models, can be used.

Likelihood calculator 402 processes environment state information 405, rule-based predictions 406, and learning-based predictions 407 to compute likelihoods 409, which represent the probabilities that the environment state information 405 would occur under the prediction models 302 and 303 being considered. Likelihoods 409 measure of how well the predictions of a prediction model (e.g., rule-based prediction model 302 or learning-based prediction model 303) match up with the actual observed outcomes, with higher likelihoods indicating a better fit between forecasts of the prediction model and the environment state information that is observed. Returning to the vehicle example, the environment state information can include an observed vehicle trajectory that is compared with trajectory distributions predicted by each of rule-based prediction model 302 and learning-based prediction model 303 to compute likelihoods 409. In various embodiments, likelihood calculator 402 uses the performance metric Γ in performance metric module 401 to compute likelihoods 409 which describe how closely learning-based predictions 407 {x_{t+1,i}^{l}}ᵢ₌₁^{N} align with the and rule-based predictions 406 {x_{t+1,i}^{r}}ᵢ₌₁^{N} align with the actual environment state information 405, denoted herein by xₜ₊₁, using a set of performance metrics. For example, if a performance metric in performance metric module 401 indicates a lower average displacement error or a higher likelihood as per a kernel density estimate for the learning-based predictions 407, the likelihoods will favor the learning-based prediction model 303. Similarly, should the rule-based predictions 406 yield a lower average displacement error, final displacement error, and/or the like, the corresponding likelihoods 409 will be adjusted upwards accordingly. In various embodiments, direct computation of likelihood is not feasible; instead, likelihood is approximated using performance metrics 401, denoted herein by Γ^{l} and Γ^{r}. For example, in some embodiments, the performance metrics can include average displacement error, final displacement error, likelihood estimates from a kernel density function, downstream planning cost, and/or the like. Using the performance metrics 401, likelihood calculator 402 calculates likelihoods 409 as

$$α = \frac{{Γ}^{l}}{{Γ}^{{r}^{′}}} \qquad ( 3 )$$

where Γ^{l} is the performance metric for learning-based predictions 407 and Γ^{r} is the performance metric for rule-based predictions 406. The performance metrics serve as a proxy for the likelihood of observing environment state information 405, xₜ₊₁, with higher metrics suggesting a higher likelihood of accuracy in predictions.

Belief updater 403 processes likelihoods 409 and a previous belief 408, which is stored in a belief storage 405 to compute an updated belief 410. In some embodiments, belief updater 403 can use any technically feasible statistical technique(s) to continually refine beliefs in the rule-based prediction model 302 and learning-based prediction model 303 and continuously recalibrate prediction fusion module 305 to output outcomes that reflect the latest, most reliable composite understanding of the environment state information. In various embodiments, belief updater 403 uses a Bayesian framework. At the onset of each evaluation cycle, also sometimes referred to as an “episode,” belief updater 403 initializes with a prior belief, b₀, stored in hyperparameters 301. Each update cycle consists of two primary steps: the observation step and the mixing step. In the observation step, upon receiving the new agent state xₜ₊₁, Bayes' rule is employed to compute the conditional probabilities:

$${b}_{t + 1}^{l} = \frac{P ( {x}_{t + 1} \vert {y}_{t - H : t} , m , l ) {b}_{t}^{l}}{P ( {x}_{t + 1} )} \\ {b}_{t + 1}^{r} = \frac{P ( {x}_{t + 1} \vert {y}_{t - H : t , m , r ) {b}_{t}^{{r}^{′}}}}{P ( {x}_{t + 1} )} \qquad ( 4 )$$

where, bₜ₊₁^{l} and bₜ₊₁^{r} represent the updated beliefs for the learning-based and rulebased models, respectively. The terms P(xₜ₊₁|y_{t-H:t}, m, l) and P(xₜ₊₁|y_{t-H:t}, m, r) are the likelihoods of observing the new state given the historical data and the prediction model type. In some embodiments, rather than applying a standard Bayesian update, the belief updater 403 uses an η generalized Bayes update:

$${b}_{t + 1}^{l} = {α}^{η} {b}_{t + 1}^{r} , \qquad ( 5 )$$

where

$$α := ( \frac{ℙ ( {x}_{t + 1} \vert {y}_{gt - H : t} , m , l ) {b}_{t}^{l}}{ℙ ( {x}_{t + 1} \vert {y}_{t - H : t} , m , r ) {b}_{t}^{r}} ) . \qquad ( 6 )$$

The parameter η∈(0,1) denotes the learning rate stored in hyperparameters 301, dictating the speed at which beliefs are updated with new evidence xₜ₊₁. In some embodiments, post-observation of the environment state information, belief updater 403 also accounts for the possibility of behavioral switching by the agent using a mixing of the updated belief with the prior belief b₀:

$${b}_{t + 1} = ( 1 - γ ) \frac{{α}^{η}}{a + {α}^{η}} + γ {b}_{0} , \qquad ( 7 )$$

where, γ is a small positive constant, close to zero, representing the likelihood of a prediction model switch at any given timestep. As described, the prior belief is a predefined belief, and mixing with the prior belief improves robustness in case the performances of the rule-based and learning-based prediction models changes in the future.

FIG. 5 is a more detailed illustration of the prediction fusion module 305 of FIG. 3, according to various embodiments. As shown, prediction fusion module 305 includes a belief sampler 501 and an outcome generator 502.

Belief sampler 501 process updated belief 410, rule-based predictions 406, and learning-based predictions 407 to generate a set of weighted prediction samples 503. Using updated belief 410, belief sampler 501 receives N number of rule-based predictions 406, denoted by {x_{t+1,t+T,i}^{l}}ᵢ₌₁^{N}˜ P(x_{t+1:t+T}|y_{t-H:t}, m, l), and learning-based predictions 407, denoted by {x_{t+1,t+T,i}^{l}}ᵢ₌₁^{N}˜ P(x_{t+1:t+T}|y_{t-H:t}, m, l), which are present in hyperparameters 301. Belief sampler 501 draws N′ samples from learning-based predictions 407 {x_{t+1,t+T,i}^{l}}ᵢ₌₁^{N} and N^{r} samples from rule-based predictions 406 {x_{t+1,t+T,i}^{r}}ᵢ₌₁^{N}, such that N^{r}+N^{l}=N^{r}, according to the updated belief 410. In some embodiments, belief sampler 501 chooses either the first N^{l} predictions from {x_{t+1,t+T,i}^{l}}ᵢ₌₁^{N} or the first N^{r} predictions from {x_{t+1,t+T,i}^{r}}ᵢ₌₁^{N} since the predictions are independent and identically distributed, ensuring a representative selection of possible future predictions.

Outcome generator 502 receives weighted prediction samples 503 and generates a predicted outcome 504 that includes the predictions sampled from rule-based predictions 406 and learning-based predictions 407 by belief sampler 501. For example, in some embodiments, the sampled predictions can be concatenated together to generate predicted outcome 504. Predicted outcome 504 can be used in any suitable manner in some embodiments, depending on what is predicted. Returning to the vehicle example, predicted trajectories of a vehicle can be used by a planner application (which can, e.g., be combined with or separate from prediction application 126) that determines how to control an autonomous vehicle to avoid that vehicle. As a further example, predicted trajectories of an object (e.g., humans) within an environment can be used by a planner application that determines how to control a robot within the environment to interact with the object.

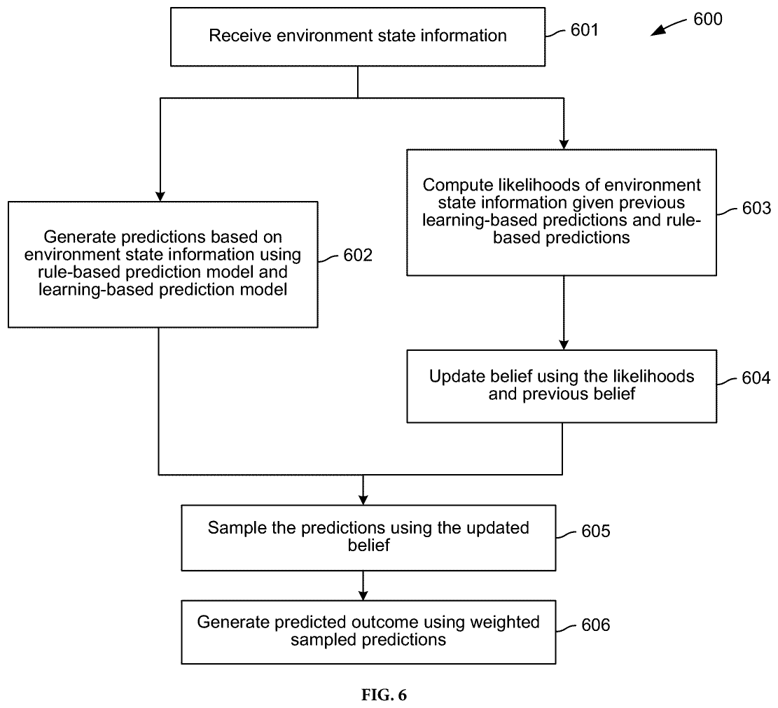

FIG. 6 is a flow diagram of method steps for combining learning-based and rule-based predictions, according to various embodiments. Although the method steps are described in conjunction with FIGS. 1-5, persons skilled in the art will understand that any system configured to perform the method steps, in any order, falls within the scope of the present invention. Although one time step is shown for simplicity, the method steps of FIG. 6 can be repeated for any number of time steps.

As shown, a method 600 begins at step 601, where prediction application 126 receives environment state information. Any suitable environment state information can be used in some embodiments, depending on the prediction to be made. In some embodiments, the environment state information can include information that is continuously collected using an array of sensors, shown in FIG. 2B and FIG. 2C-such as LIDAR sensor(s) 264, RADAR sensor(s) 260, cameras 268, 270, and 274 and/or the like. As described, in the vehicle example, the environment state information can include a position and movement of a vehicle (e.g., a historical vehicle trajectory) and a map of the environment indicating where lanes, traffic light, etc. are. In such a case, other environment state information that can be considered include the presence of pedestrians, road conditions, traffic signals, weather conditions, and/or the like.

At step 602, prediction application 126 generates predictions based on the received environment state information using rule-based prediction model 302 and learning-based prediction model 303. In some embodiments, rule-based prediction model 302 includes a rule hierarchy that allows for differentiated rule adherence, assigning higher importance to critical safety rules, such as collision avoidance, and/or the like, while permitting temporary relaxation of less crucial rules under certain conditions, such as right-of-way, and/or the like. Returning to the vehicle example, rule-based prediction model 302 can prioritize the rule of avoiding a collision over the rule of maintaining the speed limit. As a specific example, in some embodiments, rule-based prediction model 302 can use the following hierarchy of rules: collision avoidance, follow the center polyline of a lane to be followed, orient along the center polyline of the lane to be followed, and follow the speed limit. In some embodiments, rules can be expressed in formal logic, such as Signal Temporal Logic (STL), and/or the like, enabling precise definitions and evaluations of agent behaviors. In some embodiments, rule-based prediction model 302 uses robustness metrics to quantify how well each rule is satisfied. On the other hand, learning-based prediction model 303 uses generative networks to create a probability distribution of potential future states. In some embodiments, learning-based prediction model 303 draws from deep learning architectures to predict a range of possible outcomes, reflecting the probabilistic nature of agent behaviors. In various embodiments, learning-based prediction model 303 enriches the predictions with contextual information from the environment. For example, in autonomous driving, learning-based prediction model 303 uses contextual information, such as lane geometry, traffic infrastructure, and/or the like, to generate more accurate trajectory predictions.

At step 603, likelihood calculator 402 computes likelihoods 409 of environment state information 405 given previous learning-based predictions 407 and rule-based predictions 406. As described, in some embodiments, likelihood calculator 402 uses performance metrics 401 defined by a function Γ to evaluate the degree of conformance between the predicted states from both predicted models and the observed environment state information. The metrics assess the accuracy of predictions, with higher values indicating a greater match to the observed environment state. The likelihood calculator 402 uses the performance metrics to calculate the likelihoods 409, determining the probability that the observed environment state would occur under the given predictions. For example, if learning-based predictions 407 are closer to the observed environment state, indicated by a lower average displacement error or a higher score from a kernel density estimate, the likelihoods will tilt in favor of the learning-based prediction model 303. Conversely, if the rule-based predictions 406 more accurately reflect the observed environment state, for example, due to adherence to traffic rules as determined by a robustness metric p, the likelihoods for rule-based predictions 406 will increase. In various embodiments, likelihood calculator 402 approximates likelihoods 409 using the performance metrics Γ^{l} and Γ^{r}, corresponding to the learning-based and rule-based prediction models respectively. For example, the performance metrics can be based on various factors, including but not limited to the average displacement error or other relevant metrics, to gauge the predictive accuracy of each model. Likelihoods 409 are represented by the ratio α=Γ^{l}/Γ^{r}.

At step 604, belief updater 403 updates a belief distribution using likelihoods 409 and previous belief 408. In various embodiments, belief updater 403 uses any technically feasible statistical techniques, such Bayesian update, and/or the like, to process likelihoods 409 and previous beliefs 408 and generate updated beliefs 410. With each new episode in the prediction cycle, belief updater 403 initializes the process using a prior belief b₀, stored in hyperparameters 301. The belief update process comprises two main steps: an observation step where new agent states are received and evaluated, and a mixing step that considers the potential for changes in agent behavior. In some embodiments, instead of a standard Bayesian update, belief updater 403 uses an n-generalized Bayes update, which allows for a controlled rate of belief revision, with n indicating the learning rate from the hyperparameters 301, which influences how quickly belief updater 403 incorporates new evidence into the belief distribution. In some embodiments, step 602 can be performed in parallel to steps 603 and 604.

At step 605, belief sampler 501 samples the predictions using the updated belief 410. Belief sampler 501 samples a predetermined number of predictions, which can be set in hyperparameters 301. In some embodiments, belief sampler 501 conducts a series of weighted draws, selecting a number of predictions from learning-based predictions 407 and from the rule-based predictions 406 such that the total number of selected predictions equals the total number of predictions from hyperparameters 301. Informed by the updated belief 410, belief sampler 501 assigns weights that determine the proportion of predictions by each of rule-based prediction model 302 and learning-based prediction model 303 that should be sampled. For example, if rule-based predictions 406 has been recently outperforming in scenarios with clear-cut traffic rules, which can be reflected in updated belief 410, belief sampler 501 can allocate more weight to rule-based predictions 406. Conversely, in environments with unpredictable elements, such as dynamic urban settings, a higher weighting can be given to learning-based predictions 407 that includes a diverse set of trajectories, according to updated belief 410. In certain embodiments, belief sampler 501 either first samples learning-based predictions 407 or rule-based predictions 406, under the statistical assumption that the predictions are independent and identically distributed.

At step 606, outcome generator 502 generates predicted outcome 504 using weighted sample predictions 503. Outcome generator 502 is equipped with decision-making algorithms that analyze the weighted prediction samples 503. In some embodiments, predicted outcome 504 can include the predictions sampled from rule-based predictions 406 and learning-based predictions 407 at step 605. For example, in some embodiments, the sampled predictions can be concatenated together to generate predicted outcome 504. Further, predicted outcome 504 can be used in any suitable manner in some embodiments, such as to determine how to control an autonomous vehicle or a robot.

In sum, a prediction application combines predictions by a learning-based prediction model and predictions by a rule-based prediction model. The prediction application initializes the learning-based and the rule-based prediction models and hyperparameters that define the number of outcome samples, prediction horizon, and a Bayesian learning rate. At each time step, the prediction application updates a history of outcomes predicted by both the rule-based and learning-based prediction models. The prediction application then observes a current environment state to calculate likelihoods, informing a belief about the reliability of each model. The belief is updated using the Bayes rule to obtain conditional probabilities of observing the current environment state given historical predictions by the rule-based and learning-based prediction models, and the belief can be calculated as a weighted sum of a ratio of the conditional probabilities and a prior belief. Subsequently, the prediction application samples new outcomes predicted by both the learning-based and rule-based prediction models. The samples are blended according to the updated belief to yield a fused predicted outcome. The fused predicted outcome represents the most likely outcome considering both the patterns learned from data by the learning-based prediction model and adherence to rules by the rule-based prediction model. The process iterates, continually refining the belief and improving the fused predicted outcome accuracy over time. The fused predicted outcome can be used in any suitable manner, such as to control an autonomous vehicle.

At least one technical advantage of the disclosed techniques relative to the prior art is that, by combining predictions from a rule-based model with predictions from a learning-based model, the disclosed techniques can generate more accurate predictions for scenarios not included in historical data used to train the learning-based model. Furthermore, the disclosed techniques integrate causal reasoning through rule-based logic in the rule-based model, thereby enhancing the generalization capabilities to new scenarios. These technical advantages represent one or more technological improvements over prior art approaches.

1. In some embodiments, a computer-implemented method for processing data comprises performing one or more operations to determine a performance of one or more predefined rules based on data that is received and one or more first predictions generated using the one or more predefined rules, performing one or more operations to determine a performance of a trained machine learning model based on the data and one or more second predictions generated using the trained machine learning model, processing the data using the one or more predefined rules to generate one or more third predictions, processing the data using the trained machine learning model to generate one or more fourth predictions, and generating one or more fifth predictions based on the one or more third predictions, the one or more fourth predictions, the performance of the one or more predefined rules, and the performance of the trained machine learning model.

2. The computer-implemented method of clause 1, further comprising performing one or more Bayes rule update operations to determine a belief based on the performance of the one or more predefined rules, the performance of the trained machine learning model, and a previous belief, wherein the one or more fifth predictions are generated based on the one or more third predictions, the one or more fourth predictions, and the belief.

3. The computer-implemented method of clauses 1 or 2, wherein the belief is further determined based on a predefined prior belief.

4. The computer-implemented method of any of clauses 1-3, wherein the one or more first predictions and the one or more second predictions were generated during a previous time step.

5. The computer-implemented method of any of clauses 1-4, wherein each of the performance of the one or more predefined rules and the performance of the trained machine learning model is determined based on a loss function.

6. The computer-implemented method of any of clauses 1-5, wherein the loss function computes at least one of an average displacement error, a final displacement error, a likelihood of kernel density estimate, or a downstream planning cost.

7. The computer-implemented method of any of clauses 1-6, wherein generating the one or more fifth predictions comprises sampling from the one or more third predictions and the one or more fourth predictions based on the performance of the one or more predefined rules and the performance of the trained machine learning model.

8. The computer-implemented method of any of clauses 1-7, wherein the one or more rules include a plurality of rules within a hierarchy of rules ordered based on one or more priorities.

9. The computer-implemented method of any of clauses 1-8, wherein each of the one or more first predictions, the one or more second predictions, the one or more third predictions, and the one or more fourth predictions includes one or more trajectories.

10. The computer-implemented method of any of clauses 1-9, further comprising performing one or more operations to control a vehicle based on the one or more fifth predictions.

11. In some embodiments, one or more non-transitory computer-readable media store instructions that, when executed by at least one processor, cause the at least one processor to perform the steps of performing one or more operations to determine a performance of one or more predefined rules based on data that is received and one or more first predictions generated using the one or more predefined rules, performing one or more operations to determine a performance of a trained machine learning model based on the data and one or more second predictions generated using the trained machine learning model, processing the data using the one or more predefined rules to generate one or more third predictions, processing the data using the trained machine learning model to generate one or more fourth predictions, and generating one or more fifth predictions based on the one or more third predictions, the one or more fourth predictions, the performance of the one or more predefined rules, and the performance of the trained machine learning model.

12. The one or more non-transitory computer-readable media of clause 11, wherein the instructions, when executed by the at least one processor, further cause the at least one processor to perform the step of performing one or more Bayes rule update operations to determine a belief based on the performance of the one or more predefined rules, the performance of the trained machine learning model, and a previous belief, wherein the one or more fifth predictions are generated based on the one or more third predictions, the one or more fourth predictions, and the belief.

13. The one or more non-transitory computer-readable media of clauses 11 or 12, wherein the belief is further determined based on a predefined prior belief that gives equal weight to the one or more predefined rules and the trained machine learning model.

14. The one or more non-transitory computer-readable media of any of clauses 11-13, wherein the one or more first predictions and the one or more second predictions were generated during a previous time step.

15. The one or more non-transitory computer-readable media of any of clauses 11-14, wherein each of the performance of the one or more predefined rules and the performance of the trained machine learning model is determined based on a loss function.

16. The one or more non-transitory computer-readable media of any of clauses 11-15, wherein the loss function computes at least one of an average displacement error, a final displacement error, a likelihood of kernel density estimate, or a downstream planning cost.

17. The one or more non-transitory computer-readable media of any of clauses 11-16, wherein generating the one or more fifth predictions comprises sampling from the one or more third predictions and the one or more fourth predictions based on the performance of the one or more predefined rules and the performance of the trained machine learning model.

18. The one or more non-transitory computer-readable media of any of clauses 11-17, wherein the one or more rules include a plurality of rules for operating a vehicle within a hierarchy of rules ordered based on one or more priorities.

19. The one or more non-transitory computer-readable media of any of clauses 11-18, wherein the hierarchy of rules includes at least one of one or more rules for collision avoidance, one or more rules for following a center polyline of a lane, one or more rules for orienting along the center polyline, or one or more rules for following a speed limit.

20. In some embodiments, a system comprises one or more memories storing instructions, and one or more processors that are coupled to the one or more memories and, when executing the instructions, are configured to perform one or more operations to determine a performance of one or more predefined rules based on data that is received and one or more first predictions generated using the one or more predefined rules, perform one or more operations to determine a performance of a trained machine learning model based on the data and one or more second predictions generated using the trained machine learning model, process the data using the one or more predefined rules to generate one or more third predictions, process the data using the trained machine learning model to generate one or more fourth predictions, and generate one or more fifth predictions based on the one or more third predictions, the one or more fourth predictions, the performance of the one or more predefined rules, and the performance of the trained machine learning model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for processing data, the method comprising:
performing one or more operations to determine a performance of one or more predefined rules based on data that is received and one or more first predictions generated using the one or more predefined rules;
performing one or more operations to determine a performance of a trained machine learning model based on the data and one or more second predictions generated using the trained machine learning model;
processing the data using the one or more predefined rules to generate one or more third predictions;
processing the data using the trained machine learning model to generate one or more fourth predictions; and
generating one or more fifth predictions based on the one or more third predictions, the one or more fourth predictions, the performance of the one or more predefined rules, and the performance of the trained machine learning model.

2. The computer-implemented method of claim 1, further comprising performing one or more Bayes rule update operations to determine a belief based on the performance of the one or more predefined rules, the performance of the trained machine learning model, and a previous belief, wherein the one or more fifth predictions are generated based on the one or more third predictions, the one or more fourth predictions, and the belief.

3. The computer-implemented method of claim 2, wherein the belief is further determined based on a predefined prior belief.

4. The computer-implemented method of claim 1, wherein the one or more first predictions and the one or more second predictions were generated during a previous time step.

5. The computer-implemented method of claim 1, wherein each of the performance of the one or more predefined rules and the performance of the trained machine learning model is determined based on a loss function.

6. The computer-implemented method of claim 5, wherein the loss function computes at least one of an average displacement error, a final displacement error, a likelihood of kernel density estimate, or a downstream planning cost.

7. The computer-implemented method of claim 1, wherein generating the one or more fifth predictions comprises sampling from the one or more third predictions and the one or more fourth predictions based on the performance of the one or more predefined rules and the performance of the trained machine learning model.

8. The computer-implemented method of claim 1, wherein the one or more rules include a plurality of rules within a hierarchy of rules ordered based on one or more priorities.

9. The computer-implemented method of claim 1, wherein each of the one or more first predictions, the one or more second predictions, the one or more third predictions, and the one or more fourth predictions includes one or more trajectories.

10. The computer-implemented method of claim 1, further comprising performing one or more operations to control a vehicle based on the one or more fifth predictions.

11. One or more non-transitory computer-readable media storing instructions that, when executed by at least one processor, cause the at least one processor to perform the steps of:
performing one or more operations to determine a performance of one or more predefined rules based on data that is received and one or more first predictions generated using the one or more predefined rules;
performing one or more operations to determine a performance of a trained machine learning model based on the data and one or more second predictions generated using the trained machine learning model;
processing the data using the one or more predefined rules to generate one or more third predictions;
processing the data using the trained machine learning model to generate one or more fourth predictions; and
generating one or more fifth predictions based on the one or more third predictions, the one or more fourth predictions, the performance of the one or more predefined rules, and the performance of the trained machine learning model.

12. The one or more non-transitory computer-readable media of claim 11, wherein the instructions, when executed by the at least one processor, further cause the at least one processor to perform the step of performing one or more Bayes rule update operations to determine a belief based on the performance of the one or more predefined rules, the performance of the trained machine learning model, and a previous belief, wherein the one or more fifth predictions are generated based on the one or more third predictions, the one or more fourth predictions, and the belief.

13. The one or more non-transitory computer-readable media of claim 12, wherein the belief is further determined based on a predefined prior belief that gives equal weight to the one or more predefined rules and the trained machine learning model.

14. The one or more non-transitory computer-readable media of claim 11, wherein the one or more first predictions and the one or more second predictions were generated during a previous time step.

15. The one or more non-transitory computer-readable media of claim 11, wherein each of the performance of the one or more predefined rules and the performance of the trained machine learning model is determined based on a loss function.

16. The one or more non-transitory computer-readable media of claim 15, wherein the loss function computes at least one of an average displacement error, a final displacement error, a likelihood of kernel density estimate, or a downstream planning cost.

17. The one or more non-transitory computer-readable media of claim 11, wherein generating the one or more fifth predictions comprises sampling from the one or more third predictions and the one or more fourth predictions based on the performance of the one or more predefined rules and the performance of the trained machine learning model.

18. The one or more non-transitory computer-readable media of claim 11, wherein the one or more rules include a plurality of rules for operating a vehicle within a hierarchy of rules ordered based on one or more priorities.

19. The one or more non-transitory computer-readable media of claim 18, wherein the hierarchy of rules includes at least one of one or more rules for collision avoidance, one or more rules for following a center polyline of a lane, one or more rules for orienting along the center polyline, or one or more rules for following a speed limit.

20. A system, comprising:
one or more memories storing instructions; and
one or more processors that are coupled to the one or more memories and, when executing the instructions, are configured to:
perform one or more operations to determine a performance of one or more predefined rules based on data that is received and one or more first predictions generated using the one or more predefined rules,
perform one or more operations to determine a performance of a trained machine learning model based on the data and one or more second predictions generated using the trained machine learning model,
process the data using the one or more predefined rules to generate one or more third predictions,
process the data using the trained machine learning model to generate one or more fourth predictions, and
generate one or more fifth predictions based on the one or more third predictions, the one or more fourth predictions, the performance of the one or more predefined rules, and the performance of the trained machine learning model.
